(19) United States
(12) Patent Application Publication
(10) Pub. No.: US 2005/0270422 A1
(43) Pub. Date: Dec. 8, 2005

(54) System and method for implementing an intelligent sleep mode in a TV

(75) Inventor: Kuan-Hong Hsieh, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/025,812

(22) Filed: Dec. 28, 2004

(30) Foreign Application Priority Data
Jun. 2, 2004 (TW) 93102724

(51) Int. Cl. H04N 5/63

(52) U.S. Cl. 348/553; 348/730

(57) ABSTRACT

A system for implementing an intelligent sleep mode in a TV includes an audio amplifier (20), a digital signal processor (DSP) (11), and a timer (12), a pulse width modulation (PWM) output port (13) and a low-voltage differential signaling (LVDS) output port (14) all of which are connected to the DSP. Each time the intelligent sleep mode is started, the timer times an elapsed time during which no button signal is received by the DSP. When the elapsed time reaches a preset sleep mode time, the DSP decreases the volume of the TV through the PWM output port, and decreases the brightness of the TV through the LVDS output port. If the brightness and volume of the TV have been decreased in all of preset phases, and still no button signal is received, the DSP automatically shuts off the TV. A related method is also provided.

### BACKGROUND OF THE INVENTION

1. Field of the Invention

The present invention generally relates to a system and method for implementing an intelligent sleep mode in a television.

2. Prior art of the Invention

Watching TV helps many people relieve stress and tiredness. It is easy to fall asleep when watching TV. When a viewer falls asleep while the TV is still on, this wastes power, reduces the working lifetime of the TV, and may also annoy other people who want a quiet environment.

To prevent these problems, a viewer can take advantage of the so-called sleep mode function of a TV which operates when he/she falls asleep. There are numerous technologies regarding the sleep mode function of TVs, such as that disclosed in U.S. Pat. No. 5,894,331 entitled “METHOD OF CHECKING SLEEP MODE FUNCTION IN A TV.” The operation of this invention is represented in FIG. 3. According to the invention, when a set sleep mode time is reached, the TV is directly powered off if the viewer gives no response to a message which is provided to confirm the viewer's continued viewing.

However, when the TV is powered off from a normal “on” state, the sharp changes of current passing through the components of the TV can damage the components. This may result in reducing the working lifetimes of the components and the working lifetime of the TV.

Thus there is a need for a system and method which not only reduces unnecessary consumption of power, but also avoids sharp changes of current passing through components of a TV when a viewer falls asleep while watching the TV.

### SUMMARY OF THE INVENTION

Accordingly, it is a first objective of the present invention to provide a system for implementing an intelligent sleep mode in a TV, by decreasing the brightness and volume of the TV in phases and finally turning off the TV automatically.

It is a second objective of the present invention to provide a method for implementing an intelligent sleep mode in a TV, by decreasing the brightness and volume of the TV in phases and finally turning off the TV automatically.

To fulfill the aforementioned first objective, a system for implementing an intelligent sleep mode in a TV (hereinafter, “the system”) in accordance with a preferred embodiment of the present invention is provided herein. The system comprises a control chip and an audio amplifier. The control chip comprises a digital signal processor (DSP), and a timer, a pulse width modulation (PWM) output port, and a low-voltage differential signaling (LVDS) output port all of which are connected to the DSP. The timer times an elapsed time during which no button signal is received by the DSP each time the intelligent sleep mode is started. The DSP controls the audio amplifier to adjust the volume of the TV through the PWM output port, and controls a display apparatus of the TV and adjusts the brightness of the display apparatus through the LVDS output port.

The DSP comprises a microprocessor, a RAM (random-access memory), and an EEPROM (electrically erasable and programmable read-only memory). The RAM stores all information used and generated by the system, including the viewer-preset parameters. The EEPROM also stores the viewer-preset parameters. Each time the intelligent sleep mode is started, the microprocessor obtains the viewer-preset parameters from the RAM, and controls the brightness and volume of the TV according to the viewer-preset parameters and button signals received from an infrared remote controller or a panel of the TV.

To fulfill the aforementioned second objective, the present invention provides a method for implementing an intelligent sleep mode in a TV. The method in its simplest form comprises the following steps: (a) determining whether the intelligent sleep mode is started; (b) entering into an initial status and starting to time an elapsed time during which no button signal is received, if the sleep mode is started; (c) determining in real time whether any button signal is received; (d) decreasing a brightness and volume of the TV if no button signal is received and the elapsed time reaches a corresponding sleep mode time; and (e) shutting off the TV. Further, steps (c) and (d) can be repeated a preset number of times, each repeat of step (c) and (d) involving a respective preset amount by which the brightness and volume of the TV is decreased, and a corresponding respective preset sleep mode time.

These and other objectives, advantages and new features of the present invention will be drawn from the following detail description of a preferred embodiment and method in conjunction with the accompanying drawings, in which:

### BRIEF DESCRIPTION OF THE DRAWINGS

FIG. 1 is a block diagram of a system for implementing an intelligent sleep mode in a TV in accordance with the preferred embodiment of the present invention;

FIG. 2 is a flowchart of a preferred method for implementing an intelligent sleep mode in a TV by utilizing the system of FIG. 1; and

FIG. 3 is flowchart of implementing a sleep mode in a TV in accordance with the prior art.

### DETAILED DESCRIPTION OF THE PREFERRED EMBODIMENT

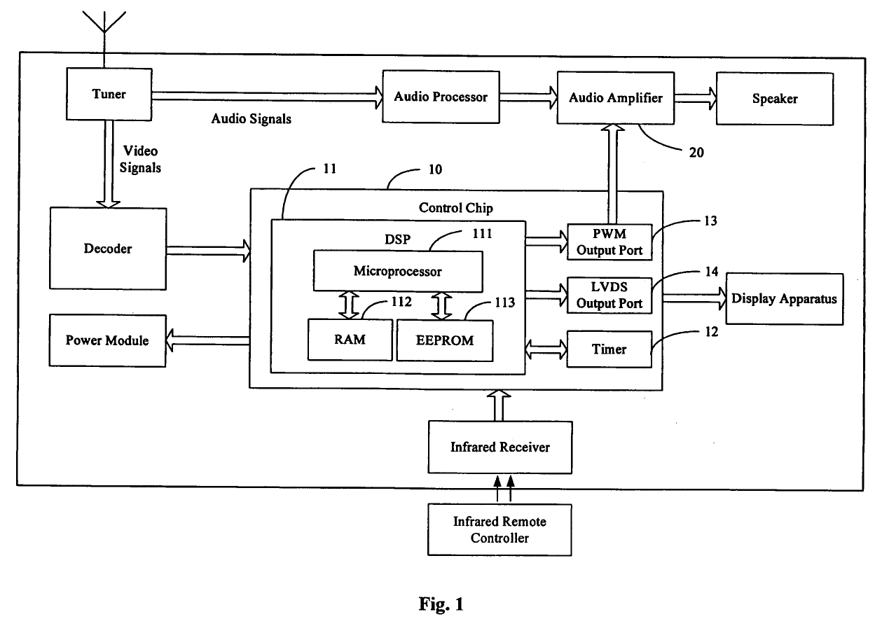

FIG. 1 is a block diagram of a system of the present invention for implementing an intelligent sleep mode in a TV (hereinafter, “the system”). According to the preferred embodiment, once a viewer of the TV starts the intelligent sleep mode of the TV, the brightness and volume of the TV is decreased in phases, and finally the power of the TV is automatically turned off. The following are viewer-preset parameters stored in the system: the number of phases n in which the brightness and volume of the TV is to be decreased, the percentages (X1%, X2%, Xn%) by which the brightness and volume of the TV are decreased in each phase, and the sleep mode times (T1, T2, . . . , Tn) each of which corresponds to a phase. Each percentage indicates a ratio of a reduction in brightness and volume of the TV compared to an initial starting brightness and volume of the TV. Generally, the sleep mode times and the percentages each increase in value sequentially. That is, T1<T2< . . . <Tn, and X1%<X2%< . . . <Xn%.

To accomplish the above-mentioned intelligent sleep mode, the system includes a control chip 10 and an audio amplifier 20. The control chip 10 is programmed for receiving the viewer-preset parameters, controlling outputs of audio and video signals of the TV, and controlling a power module (not labeled) to shut off the TV when all sleep mode times are reached. The audio amplifier 20 is for decreasing intensities of the audio signals, and therefore decreasing the volume of the TV. The control chip 10 comprises a digital signal processor (DSP) 11, and a timer 12, a pulse width modulation (PWM) output port 13 and a low-voltage differential signaling (LVDS) output port 14 all of which are connected to the DSP 11. Each time the intelligent sleep mode is started, the timer 12 times an elapsed time T during which no button signal is received by the DSP 11. The DSP 11 controls the audio amplifier 20 to adjust the volume of the TV through the PWM output port 13, and controls a display apparatus (not labeled) of the TV and adjusts the brightness of the display apparatus through the LVDS output port 14.

The DSP 11 comprises a microprocessor 111, a RAM (random-access memory) 112, and an EEPROM (electrically erasable and programmable read-only memory) 113. The RAM 112 is for storing all information used and generated by the system, including the viewer-preset parameters. The EEPROM 113 is also for storing the viewer-preset parameters. The microprocessor 111 is for receiving button signals from an infrared remote controller (not labeled) through an infrared receiver (not labeled) and from a TV panel (not shown), obtaining viewer-preset parameters from the RAM, and controlling the brightness and volume of the TV according to the button signals and the viewer-preset parameters.

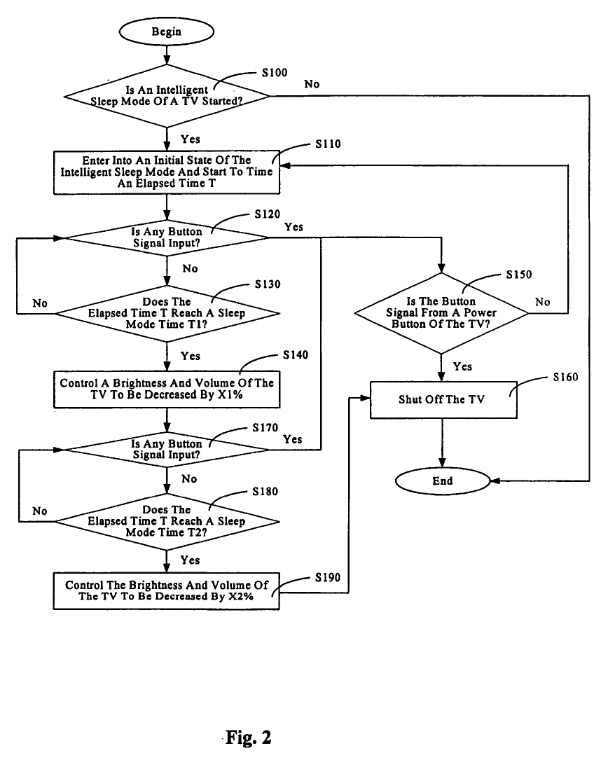

FIG. 2 is a flowchart of the preferred method for implementing an intelligent sleep mode in a TV by utilizing the system. In the preferred method, the intelligent sleep mode of the TV is started by a viewer, who presses a sleep mode button (not shown) installed on the infrared remote controller. When the sleep mode button is pressed, a signal for entering into the sleep mode is input to the microprocessor 111 through the infrared receiver. The number of phases is preset by the viewer according to personal preference. For example, the viewer may preset the number of phases as two. The procedure by which the brightness and volume of the TV are decreased in two phases is as follows:

Phase I: In step S100, the microprocessor 111 determines whether the intelligent sleep mode of the TV is started, by determining whether the sleep mode button is pressed. If the sleep mode button is not pressed, the procedure is finished. If the sleep mode button is pressed, the intelligent sleep mode is started, and in step S110, the system enters into an initial state of the intelligent sleep mode. The microprocessor 11 starts the timer 12 to time an elapsed time T during which no button signal is received by the microprocessor 111. In step S120, during the period until the elapsed time T reaches a sleep mode time T1, the microprocessor 111 detects in real time whether it receives any button signal from the infrared remote controller or the TV panel.

If any button signal is input to the microprocessor 111, in step S150, the microprocessor 111 determines whether the button signal is from a power button of the TV. If the button signal is from the power button, in step S160, the microprocessor 111 controls the power module to shut off the TV, whereupon the procedure is finished. If the button signal is not from the power button, the procedure returns to step S110 described above.

If no button signal is input to the microprocessor 111, in step S130, the microprocessor 111 determines whether the elapsed time T has reached the sleep mode time T1. If the elapsed time T has not reached the sleep mode time T1, the procedure returns to step S120 described above. If and when the elapsed time T has reached the sleep mode time T1, in step S140, the microprocessor 111 controls the brightness and volume of the TV to be decreased by X1%.

Phase II: After successfully decreasing the brightness and volume of the TV by X1% in phase I, in step S170, during the period until the elapsed time T reaches a sleep mode time T2, the microprocessor 111 detects in real time whether it receives any button signals from the infrared remote controller or the TV panel. If any button signal is input to the microprocessor 111, the procedure returns to step S150 described above. If no button signal is input to the microprocessor 111, in step S180, the microprocessor 111 determines whether the elapsed time T has reached the sleep mode time T2. If the elapsed time T has not reached the sleep mode time T2, the procedure returns to step S170 described above. If and when the elapsed time T has reached the sleep mode time T2, in step S190, the microprocessor 111 controls the brightness and volume of the TV to be decreased by X2%, whereupon the procedure goes to step S160 described above.

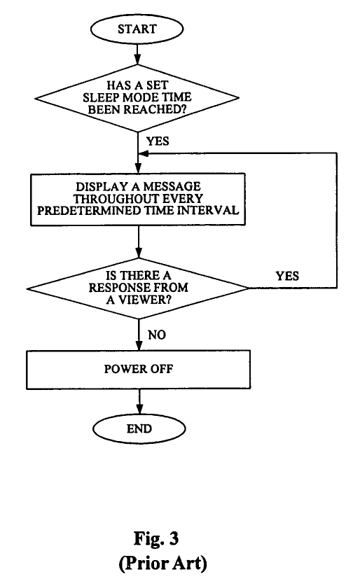

The above-described procedure decreases the brightness and volume of the TV in two phases. The viewer may preset the number of phases to any natural number greater than zero according to personal preference. When the viewer presets the number of phases to be other than two, the procedure is similar to that described and shown in relation to FIG. 3, except that phase II is omitted or one or more phases similar to phase II are added.

Although the present invention has been specifically described on the basis of a preferred embodiment and preferred method, the invention is not to be construed as being limited thereto. Various changes and modifications may be made to the embodiment and method without departing from the scope and spirit of the invention.

1. A system for implementing an intelligent sleep mode in a TV, comprising:
a control chip for controlling outputs of audio and video signals of the TV, comprising:
a digital signal processor (DSP);
a timer for timing an elapsed time during which no button signal is received by the DSP;
a pulse width modulation (PWM) output port connected to the DSP; and
a low-voltage differential signaling (LVDS) output port connected to the DSP; and
an audio amplifier which connects with the PWM output port and is used to decrease the intensities of the audio signals;
wherein the DSP controls the audio amplifier to adjust the volume of the TV through the PWM output port, and controls a display apparatus of the TV and adjusts the brightness of the display apparatus through the LVDS output port.

2. The system as claimed in claim 1, wherein the DSP comprises a random-access memory (RAM) for storing all information generated and used by the system.

3. The system as claimed in claim 1, wherein the DSP comprises an electrically erasable and programmable read-only memory (EEPROM) for storing viewer-preset parameters.

4. The system as claimed in claim 3, wherein the viewer-preset parameters comprises a number of phases that brightness and volume of the TV is to be decreased, the percentages in each phase that the brightness and volume of the TV is to be decreased, and sleep mode times.

5. The system as claimed in claim 2, wherein the DSP further comprises a microprocessor, which can receive button signals from an infrared remote controller or a TV panel, obtain viewer-preset parameters from the RAM, and control the brightness and volume of the TV according to the button signals and the viewer-preset parameters.

6. A method for implementing an intelligent sleep mode in a TV, the method comprising the steps of:
(a) determining whether the sleep mode is started;
(b) entering into an initial status and starting to time an elapsed time during which no button signal is received, if the sleep mode is started;
(c) determining in real time whether any button signal is input by a user;
(d) decreasing a brightness and volume of the TV by a preset amount if no button signal is input and the elapsed time reaches a preset sleep mode time; and
(e) shutting off the TV.

7. The method as claimed in claim 6, further comprising repeating steps (c) and (d) a preset number of times, each repeat of steps (c) and (d) involving a respective preset amount by which the brightness and volume of the TV is decreased, and a corresponding respective preset sleep mode time, wherein the brightness and volume of the TV are decreased in successive phases.

8. The method as claimed in claim 7, wherein the number of phases in which the brightness and volume of the TV are decreased is preset by a viewer.

9. The method as claimed in claim 6, further comprising the step of determining whether the button signal is from a power button, if any button signal is received.

10. The method as claimed in claim 9, further comprising the step of turning off the TV if the button signal is from the power button.

11. The method as claimed in claim 9, further comprising the step of returning to step (b) if the button signal is not from the power button.

12. A method for implementing a sleep mode on a television, the method comprising the steps of:
starting said sleep mode based on user control signals;
evaluating an elapsed time after said starting step in case that no another user control signal is available;
reducing an extent of display performance of said television in a predetermined ratio after said elapsed time is up to a first time value;
repeating said reducing step based on another ratio and time value; and
shutting off said television after said elapsed time is up to a second time value.

13. The method as claimed in claim 12, wherein said display performance of said television includes brightness of displaying images and volume of television audio.

14. The method as claimed in claim 12, further comprising the step of re-evaluating said elapsed time in case of retrieving said another user control signal.

15. The method as claimed in claim 12, further comprising the step of setting a number of repeating said reducing step before said starting step.
